(19) United States
(12) Patent Application Publication
(10) Pub. No.: US 2026/0181090 A1
(43) Pub. Date: Jun. 25, 2026

(54) IMAGE READING APPARATUS

(71) Applicant: BROTHER KOGYO KABUSHIKI KAISHA, Nagoya (JP)

(72) Inventor: Thanh NGUYENVAN, Nagoya (JP)

(73) Assignee: BROTHER KOGYO KABUSHIKI KAISHA, Nagoya (JP)

(21) Appl. No.: 19/424,953

(22) Filed: Dec. 18, 2025

(30) Foreign Application Priority Data
Dec. 24, 2024 (JP) 2024-227700

(51) Int. Cl. H04N 1/00

(52) U.S. Cl. CPC H04N 1/00811; H04N 1/00408; H04N 1/00482; H04N 1/00551; H04N 1/00689; H04N 1/00692; H04N 1/00734; H04N 1/00822; H04N 2201/0081; H04N 2201/0094

(57) ABSTRACT

An image reading apparatus includes a document table, an automatic document feeder, a user interface, and a reading device. The image reading apparatus is configured to perform reading using a first method in which the reading device reads an image of a document being conveyed by the automatic document feeder and image data is generated based on a reading result, or a second method in which the reading device reads an image of a document placed on the document table while the reading device is moved along the document table and image data is generated based on a reading result. The image reading apparatus is further configured to perform a continuous reading setting as to whether to enable or disable continuous reading, in accordance with an operation via the user interface.

### REFERENCE TO RELATED APPLICATIONS

This application claims priority from Japanese Patent Application No. 2024-227700 filed on Dec. 24, 2024. The entire content of the priority application is incorporated herein by reference.

### BACKGROUND ART

In related art, image reading apparatuses are known that can perform both an FB reading method, in which a document is set on a flatbed (FB) serving as a manually placed document table and an optical unit that optically reads an image is moved along the document table to read an image of the document, and an ADF reading method, in which the optical unit is fixed and a document is conveyed by an automatic document feeder (ADF) to read the document. Techniques for switching these two reading modes to perform continuous reading are also known.

For example, a related art reference discloses a configuration in which, when a start of reading is instructed, either ADF reading method or FB reading method is selected and reading of a document is performed, a user designation as to whether to continuously perform reading is received every time one reading operation is completed, and when continuation is designated, either the ADF reading method or the FB reading method is selected and reading of a document is performed, and image data generated as a result thereof is treated as a continuation of image data generated by the previous reading operations.

In an image reading apparatus capable of performing reading by two reading methods of an ADF reading method and an FB reading method, a new technique is desired in a case where continuous reading is performed.

### SUMMARY

An image reading apparatus includes a document table, an automatic document feeder, a user interface, and a reading device. The image reading apparatus is configured to perform reading using a first method in which the reading device reads an image of a document being conveyed by the automatic document feeder and image data is generated based on a reading result, or a second method in which the reading device reads an image of a document placed on the document table while the reading device is moved along the document table and image data is generated based on a reading result. The image reading apparatus is further configured to perform a continuous reading setting as to whether to enable or disable continuous reading, in accordance with an operation via the user interface. In response to completion of reading using the first method, the image reading apparatus is configured to in a case where the continuous reading is set to be enabled as the continuous reading setting, enter a state of waiting to receive a continuation instruction via the user interface, in the state of waiting to receive the continuation instruction, in a case where the continuation instruction is received, cause the reading device to read an image of a subsequent document, and in the state of waiting to receive the continuation instruction, in a case where the continuation instruction is not received, combine image data obtained through all readings performed thus far and output the combined data. In a case where the continuous reading is set to be disabled as the continuous reading setting, not enter a state of waiting to receive a continuation instruction, and combine image data obtained through all readings performed thus far and output the combined data. In response to completion of reading using the second method, the image reading apparatus is configured to regardless of whether the continuous reading is set to be enabled or disabled as the continuous reading setting, enter a state of waiting to receive a continuation instruction via the user interface, and in the state of waiting to receive the continuation instruction, in a case where the continuation instruction is received, cause the reading device to read an image of a subsequent document, and in the state of waiting to receive the continuation instruction, in a case where the continuation instruction is not received, combine image data obtained through all readings performed thus far and output the combined data.

### BRIEF DESCRIPTION OF DRAWINGS

FIG. 1 is a diagram illustrating a schematic configuration of an MFP according to the present embodiment.

FIG. 2 is a diagram illustrating an example of a configuration of a cover.

FIG. 3 is a flowchart illustrating an example of a procedure of a reading process.

FIG. 4A is a diagram illustrating an example of a scan setting screen.

FIG. 4B is a diagram illustrating an example of the scan setting screen.

FIG. 5 is a diagram illustrating an example of a continuous reception screen.

FIG. 6 is a flowchart illustrating an example of a procedure of the reading process.

FIG. 7 is a flowchart illustrating an example of a procedure of the reading process.

FIG. 8 is a flowchart illustrating an example of a procedure of a continuous reading process.

FIG. 9 is a diagram illustrating an example of a reading method selection screen.

### DESCRIPTION

Hereinafter, a first embodiment embodying an image reading apparatus will be described in detail with reference to the accompanying drawings. The present specification discloses a multifunction peripheral (hereinafter, referred to as an “MFP”) having an image reading function.

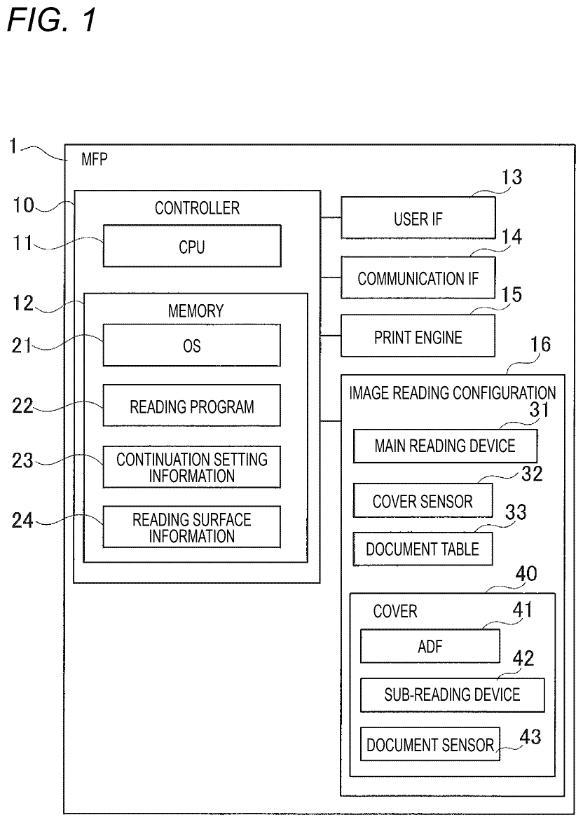

As illustrated in FIG. 1, an MFP 1 according to the present embodiment includes, for example, a controller 10 including a CPU 11 and a memory 12. The MFP 1 includes a user interface (hereinafter, referred to as a “user IF”) 13, a communication interface (hereinafter, referred to as a “communication IF”) 14, a print engine 15, and an image reading configuration 16 that are electrically connected to the controller 10. The MFP 1 is an example of the image reading apparatus. The controller 10 in FIG. 1 is a collective term for hardware and software used to control the MFP 1, and does not necessarily represent a single piece of hardware actually present in the MFP 1.

The CPU 11 of the MFP 1 executes various types of processes, in accordance with a program read from the memory 12 and based on a user operation. The memory 12 of the MFP 1 stores various types of programs and various types of data including an operating system (hereinafter, referred to as an “OS”) 21, a reading program 22, continuation setting information 23, and reading surface information 24. The memory 12 is used as a work area in a case where various types of processes are executed. A buffer provided in the CPU 11 is also an example of the memory 12. The program and data will be described later in detail.

An example of the memory 12 is not limited to a ROM, a RAM, an HDD, and the like incorporated into the MFP 1, and may be a storage medium configured to be read and written by the CPU 11. For example, an external memory such as a USB memory or an HDD connected to the MFP 1, or a memory or an HDD provided in a device connected to the MFP 1 via the communication IF 14 is also an example of the memory 12.

The computer-readable storage medium is a non-transitory medium. The non-transitory medium also includes a recording medium such as a CD-ROM or a DVD-ROM, in addition to the above-described examples. The non-transitory medium is also a tangible medium. On the other hand, an electric signal conveying a program downloaded from a server on the internet is a computer-readable signal medium, which is a kind of computer-readable medium, but is not included in the non-transitory computer-readable storage medium.

The user IF 13 includes, for example, a touch panel. The touch panel includes hardware configured to display a screen for notifying a user of information, and hardware configured to receive an operation from the user. The user IF 13 may include, for example, a combination of a display and a hardware button or the like.

The communication IF 14 includes hardware for communicating with an external device. The communication IF 14 has functions compatible with communication standards such as Wi-Fi (registered trademark), Ethernet (registered trademark), and USB. The MFP 1 may include a plurality of communication IFs 14 corresponding to a plurality of communication standards.

The print engine 15 includes a configuration for printing an image on a print medium such as a sheet. An image forming method of the print engine 15 is, for example, an electrophotographic method or an ink-jet method. The MFP 1 according to the present embodiment may include the print engine 15 that is capable of executing color printing using multicolor colorants, or may include the print engine 15 that performs only monochrome printing using a single-color colorant.

The image reading configuration 16 includes a main reading device 31, a cover sensor 32, a document table 33, and a cover 40. The cover 40 includes an automatic document feeder (hereinafter referred to as “ADF”) 41 configured to automatically convey a document, a sub-reading device 42, and a document sensor 43. Each of the main reading device 31 and the sub-reading device 42 is an example of a reading device, and is an example of one of a plurality of devices. The main reading device 31 and the sub-reading device 42 may be devices configured to perform color reading for reading a document as a color image or devices configured to perform only monochrome reading.

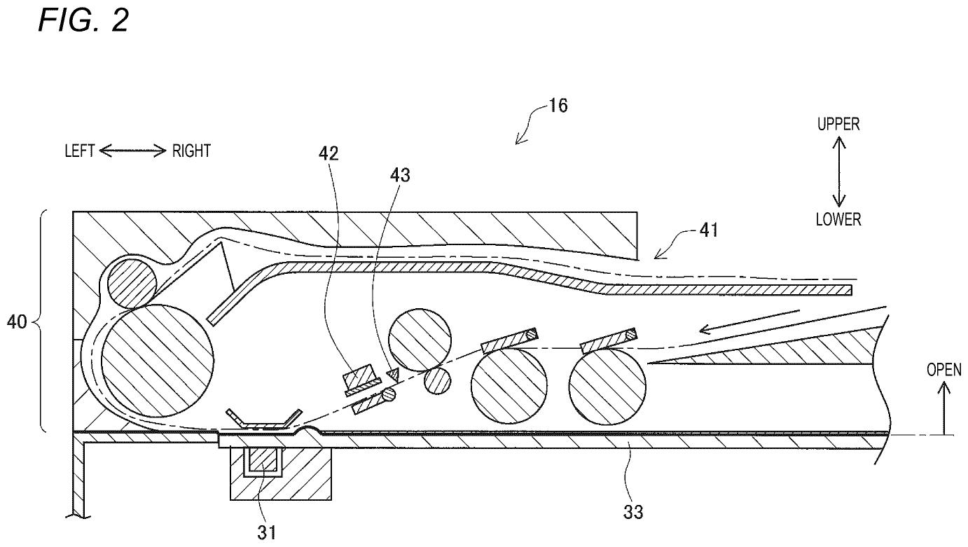

For example, as illustrated in FIG. 2, the document table 33 includes a transparent plate-shaped contact glass provided to be integrally fixed to a housing of the MFP 1. The document table 33 is also referred to as a flatbed (hereinafter, referred to as “FB”). The cover 40 is, for example, a portion above a portion indicated by a thick line in FIG. 2 and is disposed above the document table 33. The cover 40 is movable between an opened state and a closed state with respect to the document table 33 by rotating about a shaft (not illustrated) located toward the rear of the page in FIG. 2. FIG. 2 illustrates the cover 40 in a closed state. The document table 33 is exposed when the cover 40 is in the open state, and is covered by the cover 40 in the closed state. When the cover 40 is in the closed state, the ADF 41 is ready to convey a document.

Each of the main reading device 31 and the sub-reading device 42 includes reading elements arranged in a main scanning direction, which is a depth direction into the page of FIG. 2, and is configured to read an image of a document. The MFP 1 can generate image data based on a reading result by reading an image of a document using the main reading device 31 or the sub-reading device 42, and perform output based on the generated image data.

The main reading device 31 is disposed at a position below the document table 33 in FIG. 2, and is movable along the document table 33 in a sub-scanning direction, which is a left-right direction in FIG. 2. By using the main reading device 31, the MFP 1 has two types of reading methods of ADF reading and FB reading to read images. The ADF reading is an example of reading using a first method, and the FB reading is an example of reading using a second method.

The ADF reading is a reading method in which the main reading device 31, which is positioned at a predetermined position, reads an image of a document, which is placed on a document tray of the ADF 41 and conveyed one by one by the ADF 41; and conveyance of a document and reading of an image of the document are performed in parallel. The FB reading is a reading method in which the main reading device 31 reads an image of a document placed on the document table 33 while the reading device 31 is moved in the sub-scanning direction along the document table 33 to read. The main reading device 31 reads an image on a lower surface of the document on the document table 33 in FIG. 2.

The sub-reading device 42 is disposed facing a conveyance path of the document by the ADF 41, and does not move. The sub-reading device 42 reads an image on a back surface of the document being conveyed by the ADF 41, that is, an image on a surface different from the surface read by the main reading device 31. The MFP 1 can perform double-sided reading for reading images on both sides of a document by performing both reading of a first surface of the document by the main reading device 31 and reading of a second surface of the document by the sub-reading device 42 in parallel while conveying the document by the ADF 41. In this case, the main reading device 31 is an example of a first-surface reading device, and the sub-reading device 42 is an example of a second-surface reading device.

The cover sensor 32 is, for example, a light reflection sensor provided at a lower surface of the cover 40, and is configured to output different signals depending on the open state and the closed state of the cover 40. The MFP 1 is configured to detect whether the cover 40 is opened or closed based on the signal output from the cover sensor 32. The document sensor 43 is, for example, a light reflection sensor disposed in the document tray of the ADF 41, and is configured to output different signals depending on whether a document is present or absent in the ADF 41. The MFP 1 is configured to determine whether a document is detected in the ADF 41 based on the signal output from the document sensor 43.

Next, a procedure for reading an image of a document by the MFP 1 will be described. The following processes basically represent processes performed by the CPU according to instructions written in programs. That is, the processes such as “determination”, “extraction”, “selection”, “calculation”, “specification”, “obtaining”, “reception”, and “control” to be described below refer to the processes performed by the CPU. The processes performed by the CPU also include hardware control using API of the OS. In the present specification, the description of the OS is omitted, and operations of each program are described. That is, in the following description, the description that “a program B controls hardware C” may refer to “the program B controls the hardware C, using the API of the OS”. In addition, the processes performed by the CPU according to the instructions written in the programs may be described in a simplified manner. For example, the processes performed by the CPU may be described as “the CPU performs”. In addition, the processes performed by the CPU according to the instructions written in the programs may be described in words that omit reference to the CPU, such as “the program A performs”.

In addition, in the present specification, “notification”, “alert”, “notifying”, “reply”, “response”, “answer”, and the like are not limited to a meaning of transmission of information to a person, and are also used as words meaning communication or exchange of information between devices or between components in a device. The configuration in the device includes software.

The term “obtain” is used as a concept indicating that a request is not essential. That is, a process of receiving data without a request from the CPU is also included in a concept indicating that “the CPU obtains data”. In addition, the term “data” in the present specification is represented by a computer-readable bit string. Furthermore, data having substantially the same meaning and different formats are treated as the same data. The same applies to “information” used in the present specification. In addition, the terms “request” and “instruct” refer to a concept of outputting information to a counterpart that indicates a request is being made or an instruction is being given. In addition, the information indicating that a request is being made or an instruction is being given is simply referred to as a “request” or “instruction”.

In some cases, a process of the CPU determining whether information A indicates that it is a matter B may be conceptually described as “determining whether it is the matter B, based on the information A”. A process of the CPU determining whether the information A indicates that it is the matter B or a matter C may be conceptually described as “determining whether it is the matter B or the matter C, based on the information A”.

In the present specification, a setting item may be simply referred to as “setting”. A setting value may be simply referred to as “setting”. The setting value may be described as a “parameter”. Furthermore, storing the setting value in a memory or the like may be simply referred to as “setting”. An operation for setting or an input for setting may be simply referred to as “setting”.

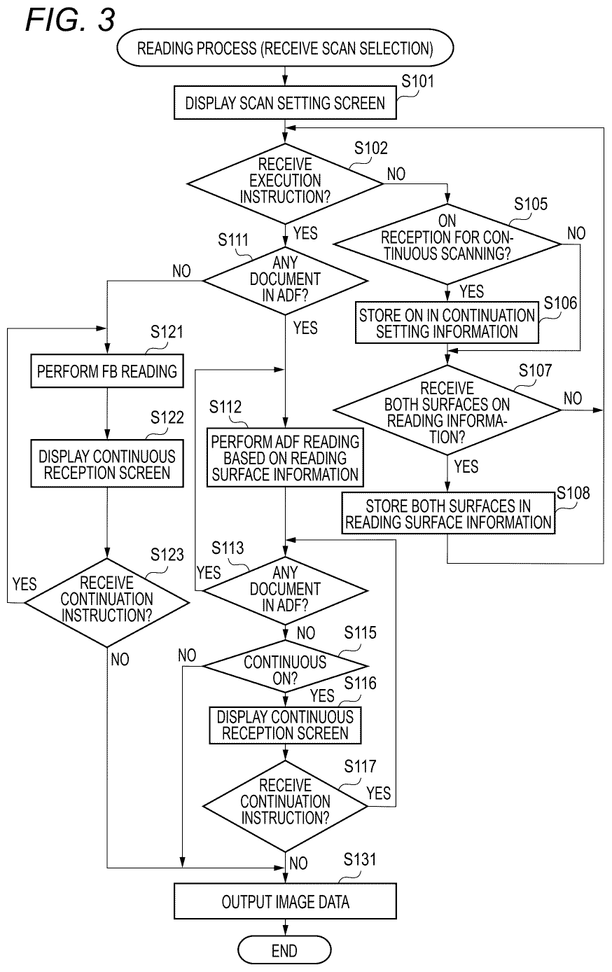

A reading process performed by the MFP 1 according to the first embodiment will be described with reference to a flowchart of FIG. 3. The reading process is performed by the CPU 11 of the MFP 1 when an instruction to select scanning is received in the MFP 1. The MFP 1 is configured to receive an instruction to select scanning through a user operation on an icon indicating scanning on a home screen, for example.

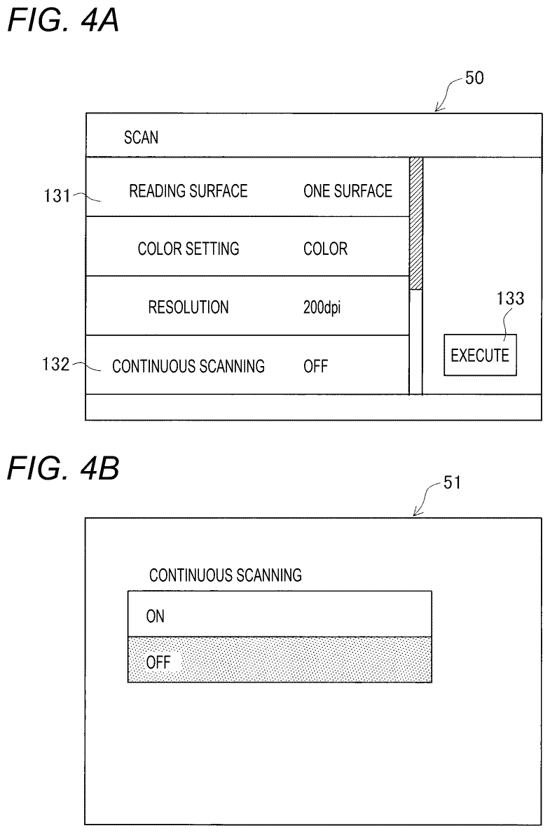

When scanning is selected, the CPU 11 causes the user IF 13 to display a scan setting screen (S101). For example, as illustrated in FIG. 4A, the CPU 11 causes the user IF 13 to display a scan setting screen 50 capable of receiving an instruction for various settings related to scanning and an instruction to start execution scanning. The scan setting screen 50 includes, for example, a button 131 for receiving a setting of reading surface, a button 132 for receiving a continuous scanning setting, and a button 133 for receiving an instruction to start execution scanning.

The CPU 11 determines whether an instruction to start execution of scanning through an operation on the button 133 is received (S102). In response to determining that the instruction to start execution of scanning is not received (S102: NO), the CPU 11 determines whether an operation on a button other than the button 133, such as the button 131 or 132, is received.

For example, when an instruction to set a continuous scanning setting is received through an operation on the button 132, the CPU 11 displays a screen 51 capable of receiving a selection of either continuous scanning ON or continuous scanning OFF, as illustrated in FIG. 4B, and receives the selection by the user. The continuous scanning ON is a setting for enabling continuous reading, and the continuous scanning OFF is a setting for disabling continuous reading. FIGS. 4A and 4B illustrate a state where the continuous scanning OFF is set.

In response to determining that the instruction to set the continuous scanning ON is received through an operation on the screen 51 (S105: YES), the CPU 11 stores information indicating the continuous scanning setting is set to ON in the continuation setting information 23 (see FIG. 1) of the memory 12 (S106). Further, the CPU 11 displays, on the button 132 of the scan setting screen 50, “ON” indicating that the continuous scanning is set to ON.

Further, for example, when an instruction to set a reading surface setting is received through an operation on the button 131, the CPU 11 displays a screen capable of receiving selection of either “both surfaces” or “one surface”, as in FIG. 4A, and receives selection by the user. The “both surfaces” is a setting for performing double-sided scanning, and the “one surface” is a setting for performing single-sided scanning. In response to determining that the selection of “both surfaces” is received (S107: YES), the CPU 11 stores information indicating “both surfaces” in the reading surface information 24 (see FIG. 1) of the memory 12 (S108). Further, the CPU 11 displays, on the button 131 of the scan setting screen 50, “ON” indicating “both surfaces”.

In response to determining that neither the instruction to set the continuous scanning setting nor the instruction to set the reading surface setting is received (S105: NO, S107: NO), the CPU 11 proceeds to S102 and determines whether the operation on the button 133 is received. The CPU 11 is capable of receiving various setting instructions through operations on the buttons 131 and 132 and other buttons any number of times until receiving an operation on the button 133, and stores selected information in the memory 12 every time receiving a user operation.

In response to determining that an instruction to start execution of scanning is received through an operation on the button 133 (S102: YES), the CPU 11 determines whether a document is present in the ADF 41 based on, for example, a signal from the document sensor 43 (S111). In response to determining that a document is present in the ADF 41 (S111: YES), the CPU 11 executes ADF reading based on the reading surface information 24 (S112).

Specifically, the CPU 11 positions the main reading device 31 at a predetermined position, and causes the ADF 41 to convey one document and read an image on one of surfaces of the document. If the information indicating “both surfaces” is stored in the reading surface information 24, the CPU 11 also causes the sub-reading device 42 to read an image of the other surface of the document. The CPU 11 generates image data based on a reading result by the main reading device 31 and a reading result by the sub-reading device 42, and temporarily stores the image data in the memory 12. If the information indicating “both surfaces” is not stored in the reading surface information 24, the CPU 11 does not cause the sub-reading device 42 to read an image.

In response to completion of the ADF reading (S112), the CPU 11 determines whether a document is present in the ADF 41 based on a signal from the document sensor 43 (S113). A plurality of documents can be placed in the ADF 41 at a time, and if there is at least one document, the document sensor 43 outputs a signal indicating that a document is present. In response to determining that a document is present in the ADF 41 (S113: YES), the CPU 11 conveys the next document and reads an image of either surface or each surface of the document in a similar manner (S112).

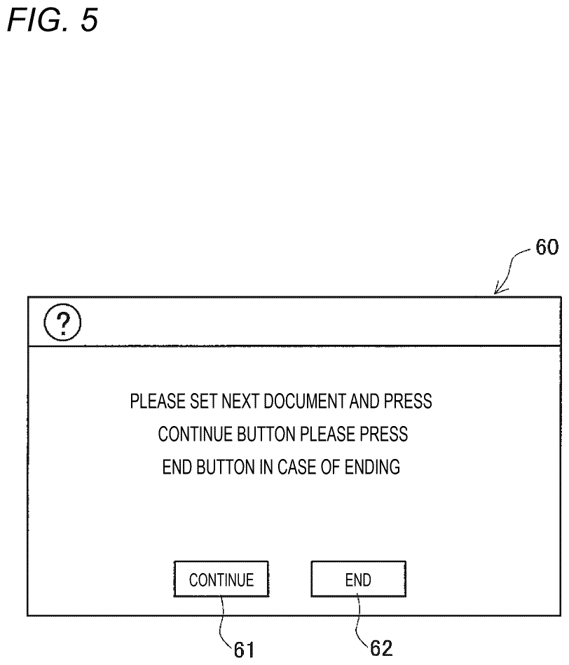

In response to determining that no document is present in the ADF 41 (S113: NO), the CPU 11 determines whether information indicating continuous scanning ON is stored in the continuation setting information 23 (S115). In response to determining that the continuous scanning ON is stored (S115: YES), the CPU 11 causes the user IF 13 to display a continuous reception screen (S116). For example, as illustrated in FIG. 5, the CPU 11 causes the user IF 13 to display a continuous reception screen 60 including a continue button 61 and an end button 62, and receives a user operation.

The CPU 11 determines whether an instruction for continuous scanning (hereinafter, referred to as a continuation instruction) is received through an operation on the continue button 61 (S117). In response to determining that the continuation instruction is received (S117: YES), the CPU 11 proceeds to S113, and if a document is present in the ADF 41 (S113: YES), the CPU 11 conveys a document and performs ADF reading (S112). In a case where no document is present in the ADF 41 when the operation on the continue button 61 is received, the CPU 11 may display the continuous reception screen 60 again or may end the scanning.

When ADF reading is performed in response to reception of a continuation instruction, the CPU 11 repeatedly performs image reading until any documents placed in the ADF 41 are no longer present (S113: NO). When the CPU 11 performs ADF reading in continuous scanning in response to receiving a continuation instruction, the CPU 11 performs double-sided reading or single-sided reading based on the reading surface information 24. That is, in continuous scanning, the CPU 11 performs a subsequent ADF reading with the same setting as that applied for the preceding ADF reading, without receiving a reading surface setting for the subsequent ADF reading from the user.

As described above, in a case where the ADF reading is continued from the preceding ADF reading, when the double-sided reading was performed in the preceding ADF reading, the MFP 1 performs the double-sided reading in the subsequent ADF reading without receiving the reading surface setting again. When the single-sided reading was performed in the preceding ADF reading, the MFP 1 performs the single-sided reading in the subsequent ADF reading without receiving the reading surface setting again. This saves the user from extra operations when the ADF reading is continued.

When the reading of all the documents placed in the ADF 41 is completed (S113: NO), the CPU 11 determines again whether the continuous scanning ON is stored (S115), and when the continuous scanning ON is stored (S115: YES), the CPU 11 displays the continuous reception screen 60 again. Even after the MFP 1 continuously performs the reading in response to reception of the continuation instruction, the MFP 1 is capable of receiving the continuation instruction in the same manner as the first reading. This enables highly convenient continuous reading.

On the other hand, in response to determining that no document is present in the ADF 41 when the CPU 11 receives the instruction to start execution of scanning (S111: NO), the CPU 11 performs FB reading (S121). That is, the CPU 11 reads an image of a document placed on the document table 33 by moving the main reading device 31 along the document table 33.

In response to completion of the FB reading (S121), the CPU 11 causes the user IF 13 to display the continuous reception screen 60 illustrated in FIG. 5 (S122), and receives an instruction from the user (S123). In response to determining that the continuation instruction through the operation on the continue button 61 is received (S123: YES), the CPU 11 performs the FB reading again (S121).

In response to determining that the continuous scanning ON is not stored (S115: NO), or in response to determining that an operation on the end button 62 is received on the continuous reception screen 60 displayed in S116 or S122 (S117: NO or S123: NO), the CPU 11 outputs the image data obtained through all readings performed thus far (S131). When reading is performed a plurality of times, for example, the CPU 11 combines a plurality of pieces of image data to create an output file and outputs the created file. For example, when an output to a USB memory is designated as the scan setting, the CPU 11 writes the created file to the USB memory connected to the MFP 1. Then, the CPU 11 ends the reading process.

As described above in detail, the MFP 1 according to the first embodiment is capable of receiving, as the scan setting, the continuous scanning setting as to whether the continuous reading is enabled or disabled. When the ADF reading is performed, the MFP 1 waits to receive a continuation instruction if the continuous scanning ON is stored as the continuous scanning setting. Therefore, the user can select whether to continue. On the other hand, when the ADF reading is performed, if the continuous scanning ON is not stored as the continuous scanning setting, the MFP 1 does not wait to receive the continuation instruction, and outputs a file based on the image data. When the FB reading is performed, the MFP 1 waits to receive a continuation instruction regardless of the continuous scanning setting. Therefore, the user can select whether to continue. Accordingly, the MFP 1 is highly convenient for continuous scanning in both ADF reading and FB reading.

Hereinafter, a second embodiment embodying an image reading apparatus will be described in detail with reference to the accompanying drawings. The MFP 1 according to the second embodiment has the same configuration as the MFP 1 according to the first embodiment, and can perform a reading process partially different from the reading process in the first embodiment. The same processes as those in the first embodiment are denoted by the same reference numerals as those in the first embodiment, and description thereof will be omitted.

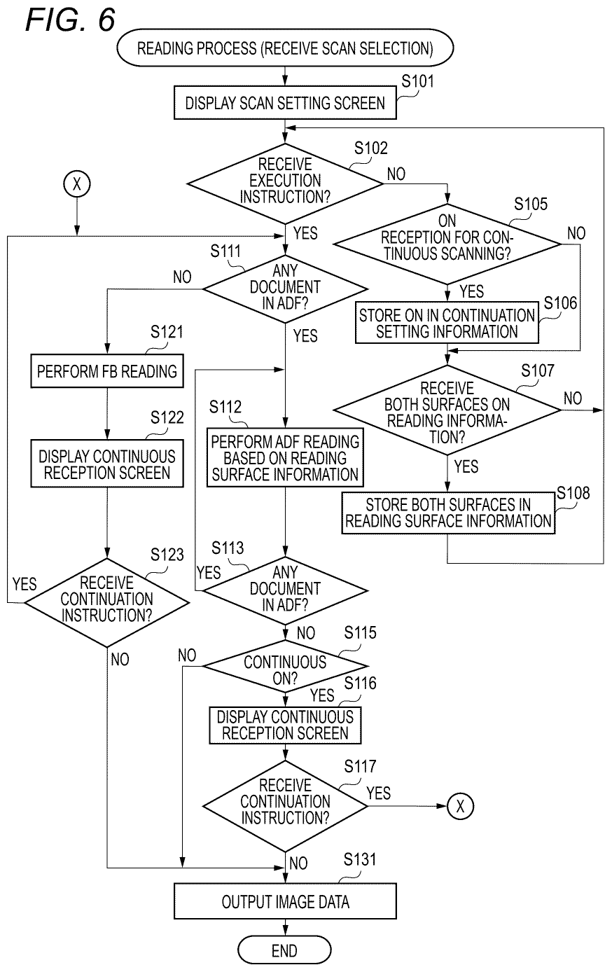

A reading process performed by the MFP 1 according to the second embodiment will be described with reference to a flowchart of FIG. 6. The reading process is performed by the CPU 11 of the MFP 1 when an instruction to select scanning is received in the MFP 1.

In the second embodiment, the CPU 11 is also capable of receiving an instruction to set a continuous scanning setting or a reading surface setting, and stores information indicating the received instruction in the memory 12. When the instruction to start execution of scanning is received (S102: YES), the CPU 11 determines whether a document is present in the ADF 41 based on, for example, the signal from the document sensor 43 (S111).

In response to determining that a document is present in the ADF 41 (S111: YES), the CPU 11 performs ADF reading based on the reading surface information 24 until any documents are no longer present in the ADF 41 (S112 to S113). In response to determining that no document is present in the ADF 41 and the continuous scanning ON is stored (S115: YES), the CPU 11 displays the continuous reception screen 60 (see FIG. 5) and receives an instruction from the user (S116 and S117).

In response to determining that no document is present in the ADF 41 (S111: NO), the CPU 11 performs FB reading (S121). When an image of one document is read, the CPU 11 displays the continuous reception screen 60 regardless of whether the continuous scanning ON is stored, and receives an instruction from the user (S122 and S123).

In response to determining that a continuation instruction through the operation on the continue button 61 is received on the continuous reception screen 60 displayed in S116 or S122 (S117: YES or S123: YES), the CPU 11 proceeds to S111, and determines whether a document is present in the ADF 41 based on the signal from the document sensor 43 (S111). The CPU 11 performs ADF reading when a document is present in the ADF 41, and performs FB reading when no document is present in the ADF 41.

That is, the MFP 1 according to the second embodiment can change a reading method for a subsequent reading when continuously performing scanning. For example, after an image of one document using FB reading, the user can place a document in the ADF 41 and operate the continue button 61 to continuously perform ADF reading subsequent to the FB reading. The MFP 1 according to the second embodiment may receive a continuation instruction, and may display a message prompting the user to place a document on the document table 33 or the ADF 41 before starting the FB reading when no document is present in the ADF 41.

The MFP 1 according to the second embodiment also performs double-sided reading or single-sided reading based on the reading surface information 24 in a case where the ADF reading is performed as the scanning to be continuously performed. For example, if the information indicating “both surfaces” is stored in the reading surface information 24, the CPU 11 performs double-sided reading without receiving a new setting from the user even in a case where the ADF reading is performed continuously after the FB reading. Accordingly, in a case where the ADF reading is performed as the scanning to be continuously performed, the user's operational effort is reduced.

In response to determining that the continuous scanning ON is not stored (S115: NO), or in response to determining that the operation on the end button 62 is received on the continuous reception screen 60 displayed in S116 or S122 (S117: NO or S123: NO), the CPU 11 outputs the image data obtained through all readings performed thus far (S131). Then, the CPU 11 ends the reading process.

As described above in detail, as in the case of the MFP 1 according to the first embodiment, the MFP 1 according to the second embodiment is capable of receiving a continuous scanning setting as to whether the continuous reading is enabled or disabled as the scan setting. Further, when a continuation instruction is received, the MFP 1 according to the second embodiment can switch the reading method depending on whether a document is placed in the ADF 41. Accordingly, the MFP 1 according to the second embodiment is highly convenient for continuous scanning in both ADF reading and FB reading, as in the case of the MFP 1 according to the first embodiment.

Hereinafter, a third embodiment embodying an image reading apparatus will be described in detail with reference to the accompanying drawings. The MFP 1 according to the third embodiment has the same configuration as the MFP 1 according to the first embodiment, and can perform a reading process partially different from the reading process in the first embodiment. The same processes as those in the first embodiment are denoted by the same reference numerals as those in the first embodiment, and description thereof will be omitted.

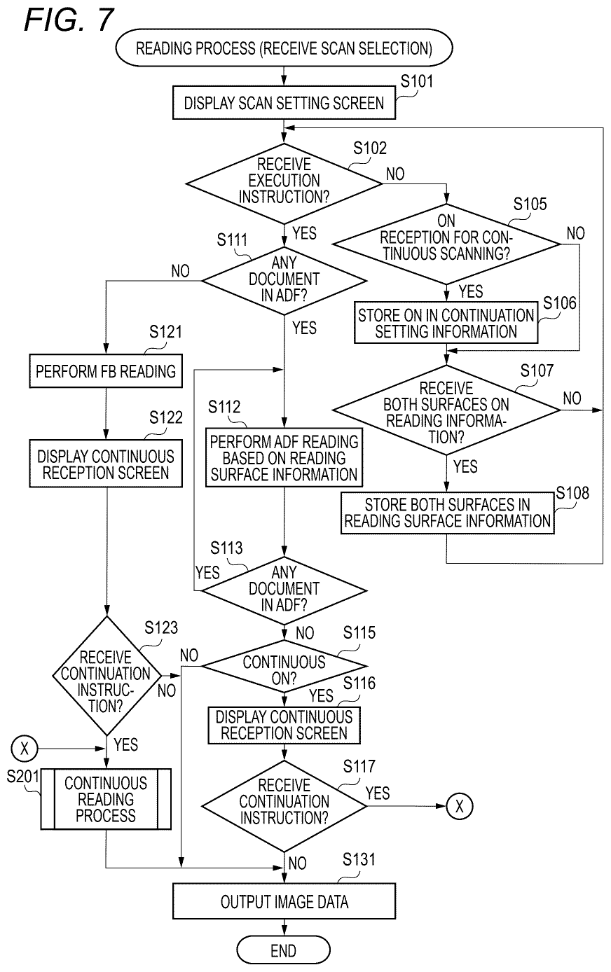

A reading process performed by the MFP 1 according to the third embodiment will be described with reference to a flowchart of FIG. 7. The reading process is performed by the CPU 11 of the MFP 1 when an instruction to select scanning is received in the MFP 1.

In the third embodiment, the CPU 11 is capable of receiving an instruction to set a continuous scanning setting or a reading surface setting, and stores information indicating the received instruction in the memory 12. When the instruction to start execution of scanning is received (S102: YES), the CPU 11 determines whether a document is present in the ADF 41 based on, for example, the signal from the document sensor 43 (S111).

In response to determining that a document is present in the ADF 41 (S111: YES), the CPU 11 performs ADF reading based on the reading surface information 24 until any documents are no longer present in the ADF 41 (S112 to S113). In response to determining that no document is present in the ADF 41 and the continuous scanning ON is stored (S115: YES), the CPU 11 displays the continuous reception screen 60 (see FIG. 5) and receives an instruction from the user (S116 to S117).

In response to determining that no document is present in the ADF 41 (S111: NO), the CPU 11 performs FB reading (S121). When the image of one document is read, the CPU 11 displays the continuous reception screen 60 and receives the instruction from the user regardless of whether the continuous scanning ON is stored (S122 to S123). In the third embodiment, after performing the ADF reading or the FB reading, the CPU 11 attempts to detect movement of the cover 40 between the opened state and the closed state with respect to the document table 33 based on the signal output from the cover sensor 32 until the continuous reception screen 60 is displayed and the user operation is received.

In response to determining that a continuation instruction through the operation on the continue button 61 is received on the continuous reception screen 60 displayed in S116 or S122 (S117: YES or S123: YES), the CPU 11 performs a continuous reading process (S201).

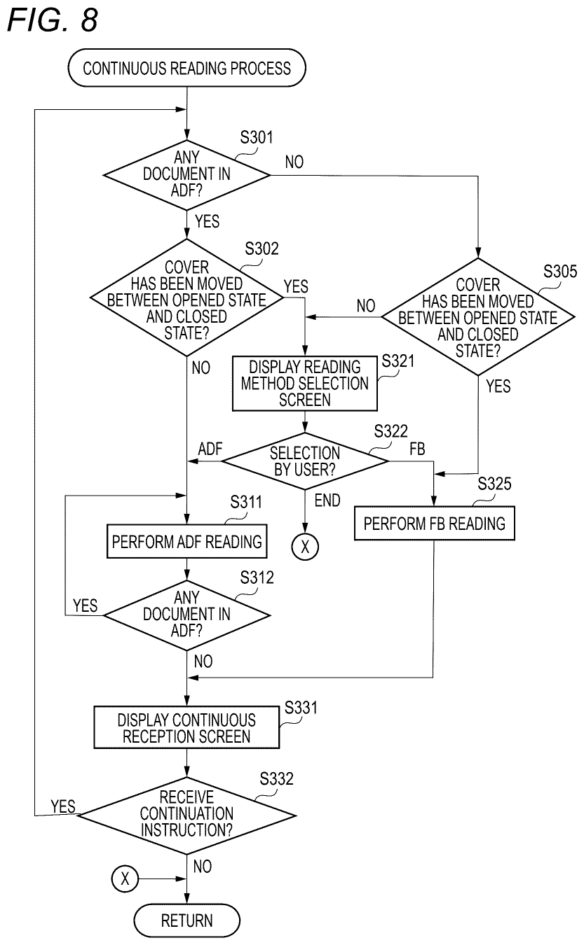

A procedure of the continuous reading process will be described with reference to a flowchart of FIG. 8. In the continuous reading process, the CPU 11 first determines whether a document is present in the ADF 41 based on the signal from the document sensor 43 (S301). In response to determining that a document is present in the ADF 41 (S301: YES), the CPU 11 determines whether the cover 40 has been moved between an opened state and a closed state with respect to the document table 33, while waiting for an operation by the user after the preceding reading (S302). Specifically, the CPU 11 determines whether the signal output from the cover sensor 32 changes until a continuation instruction is received (YES in S117) after no document is present in the ADF 41 (NO in S113 of FIG. 7) or until a continuation instruction is received (YES in S123) after the FB reading (S121).

In response to determining that the cover 40 has not been moved between the opened state and the closed state with respect to the document table 33 (S302: NO), the CPU 11 performs the ADF reading based on the reading surface information 24 (S311). The CPU 11 repeatedly performs the ADF reading until any documents are no longer present in the ADF 41 (S311 to S312).

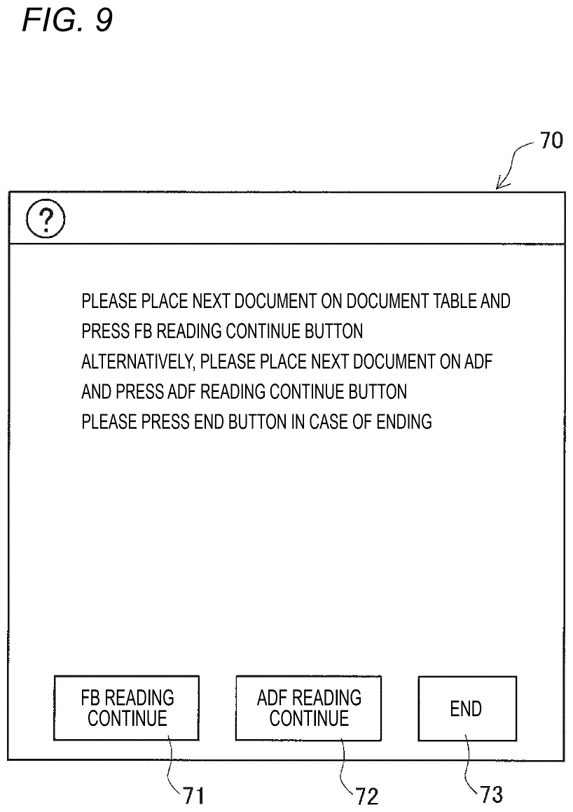

In response to determining that a document is present in the ADF 41 (S301: YES) and that the cover 40 has been moved between the opened state and the closed state with respect to the document table 33 (S302: YES), the CPU 11 causes the user IF 13 to display a reading method selection screen (S321), and receives a user operation (S322). For example, as illustrated in FIG. 9, the CPU 11 displays a reading method selection screen 70 including a continue button 71 for receiving a continuation instruction for the FB reading, a continue button 72 for receiving a continuation instruction for the ADF reading, and an end button 73 for receiving an instruction to end the reading.

In response to determining that an operation on the continue button 71 indicating the continuation instruction for the FB reading is received (S322: FB), the CPU 11 performs the FB reading (S325). In response to determining that an operation on the continue button 72 indicating the continuation instruction for the ADF reading is received (S322: ADF), the CPU 11 performs the ADF reading until any documents are no longer present in the ADF 41 (S311 to S312).

The MFP 1 according to the third embodiment is capable of receiving a change in the reading method in continuous reading. While waiting to receive the continuation instruction, when the cover 40 is not opened or closed and a document is detected in the ADF 41, the user most likely placed the document in the ADF 41 and did not place the document on the document table 33. That is, the user most likely intends to use ADF reading. Since the MFP 1 automatically starts the ADF reading when a document is present in the ADF 41 and the movement of the cover 40 with respect to the document table 33 is not detected, the user is spared the trouble of operation.

Even if a document is present in the ADF 41, when the movement of the cover 40 with respect to the document table 33 is detected, the user most likely placed the document in the ADF 41 and further placed the document on the document table 33. That is, the CPU 11 has difficulty determining whether the user intends to use the ADF reading or the FB reading. Therefore, the MFP 1 waits for the user to select a reading method and receives the selection by the user. Therefore, reading can be performed using the reading method selected by the user. Even when a document is present in the ADF 41 and the movement of the cover 40 with respect to the document table 33 is detected, if the preceding reading was performed using the FB reading, the read document has likely been removed and the next document has likely been placed in the ADF 41. Therefore, the MFP 1 may determine that the ADF reading should be performed as the scanning to be continuously performed.

On the other hand, when it is determined that no document is present in ADF 41 (S301: NO), the CPU 11 determines whether the cover 40 has been moved between the opened state and the closed state with respect to the document table 33 (S305). In response to determining that the cover 40 has been moved between the opened state and the closed state with respect to the document table 33 (S305: YES), the CPU 11 performs FB reading (S325). When no document is present in the ADF 41 and the continuation instruction is received after the cover 40 is opened or closed, the user has likely placed a document on the document table 33 instead of the ADF 41. That is, the next document has likely been placed on the document table 33. In this case, since the CPU 11 performs the FB reading, the user is spared the trouble of operation.

In response to determining that no document is present in the ADF 41 (S301: NO) and the cover 40 is not moved between the opened state and the closed state with respect to the document table 33 (S305: NO), the CPU 11 causes the user IF 13 to display a message prompting the user to set a document. For example, the CPU 11 causes the user IF 13 to display the reading method selection screen 70 illustrated in FIG. 9 (S321) and receives the selection by the user.

When no document is present in the ADF 41 and the continuation instruction is received without opening or closing the cover 40, the user has likely not placed a document in either the ADF 41 or on the document table 33. That is, no documents may have been set. Alternatively, depending on how a document was placed in the ADF 41, that the document sensor 43 may fail to detect a document although the document has been placed. Since the MFP 1 prompts the user to set a document, the user is expected to place the document again, and reading can be performed using a reading method selected by the user.

Even after the second scanning is performed in the continuous reading process, the CPU 11 receives a selection as to whether to further continue the scanning. That is, after performing the ADF reading (S311 to S312) or performing the FB reading (S325), the CPU 11 causes the user IF 13 to display, for example, the continuous reception screen 60 illustrated in FIG. 5 (S331), and receives the user operation (S332).

When the continuation instruction is received (S332: YES), the CPU 11 proceeds to S301 and determines whether to perform ADF reading or FB reading for the next scanning. In S331, the CPU 11 may display the reading method selection screen 70 illustrated in FIG. 9. In this case, the CPU 11 may determine to perform the ADF reading or the FB reading based on the user operation as in the S332.

When the operation on the end button 62 is received on the continuous reception screen 60 displayed in S331 (S322: NO), or when the operation on the end button 73 is received on the reading method selection screen 70 illustrated in FIG. 9 (S332: end), the CPU 11 ends the continuous reading process and returns to the reading process in FIG. 7.

The description returns to FIG. 7. After the continuous reading process (S201) ends, the CPU 11 outputs the image data obtained through all readings performed thus far (S131). Then, the CPU 11 ends the reading process.

As described above in detail, as in the case of the MFP 1 according to the first embodiment or the MFP 1 according to the second embodiment, the MFP 1 according to the third embodiment is capable of receiving a continuous scanning setting as to whether the continuous reading is enabled or disabled as the scan setting. Further, the MFP 1 according to the third embodiment can detect whether the cover 40 is open or closed after an image of one document is read, and automatically switch the reading method based on the detection result. Accordingly, the MFP 1 according to the third embodiment is highly convenient for continuous scanning in both ADF reading and FB reading, as in the case of the MFP 1 according to the first embodiment or the MFP 1 according to the second embodiment.

The above embodiments are merely an example, and do not limit the present invention. Therefore, various improvements and modifications can be naturally made to the technique disclosed in the present specification without departing from the gist of the present invention. For example, the image reading apparatus may be a device having an image reading function, and is not limited to the MFP 1, and may be a scanner, a copy machine, or a FAX device.

In the MFP 1 according to each embodiment described above, the image of the document is read using the common main reading device 31, both in the case of performing single-sided reading with the ADF and in the case of performing FB reading. However, different devices may be used. For example, the MFP 1 may use the sub-reading device 42 to perform single-sided reading with the ADF, and may use the main reading device 31 to perform the FB reading. In this case, the sub-reading device 42 is an example of a first reading device, and the main reading device 31 is an example of a second reading device.

Further, in each of the above-described embodiments, the MFP 1 capable of performing the double-sided scanning has been described, but the continuous scanning setting can be applied even to a device incapable of performing the double-sided scanning. In this case, the sub-reading device 42 and the reading surface information 24 may be omitted.

In each of the above-described embodiments, after performing the FB reading, the MFP 1 displays the continuous reception screen 60 regardless of the continuous scanning setting, and receives an instruction from the user, but the present disclosure is not limited thereto. For example, the MFP 1 may determine whether to perform the continuous scanning based on the continuous scanning setting even after the FB reading is performed. In addition, for example, when the MFP 1 receives an instruction to start performing scanning, if continuous scanning is not set to ON, the MFP 1 may display a message confirming that the scanning will not continue.

Further, in each of the above embodiments, the description has been given assuming that the MFP 1 waits until a user operation is received after the continuous reception screen 60 (see FIG. 5) is displayed on the user IF 13, but the present disclosure is not limited thereto. For example, the MFP 1 may determine not to perform the continuous scanning when a predetermined time has elapsed while neither the operation on the continue button 61 nor the operation on the end button 62 is received.

In any flowchart disclosed in the embodiments, the order of execution of a plurality of processes in any of a plurality of steps can be freely changed within a range in which no contradiction arises in a process content.

The processes disclosed in the embodiments may be executed by hardware such as a single CPU, a plurality of CPUs, an ASIC, or a combination thereof. In addition, the processes disclosed in the embodiments can be implemented in various forms, such as a recording medium in which a program for executing the processes is recorded, or a method.

What is claimed is:

1. An image reading apparatus comprising:
a document table;
an automatic document feeder;
a user interface; and
a reading device,
wherein the image reading apparatus is configured to perform reading using:
a first method in which the reading device reads an image of a document being conveyed by the automatic document feeder and image data is generated based on a reading result; or
a second method in which the reading device reads an image of a document placed on the document table while the reading device is moved along the document table and image data is generated based on a reading result,
wherein the image reading apparatus is further configured to perform a continuous reading setting as to whether to enable or disable continuous reading, in accordance with an operation via the user interface,
wherein, in response to completion of reading using the first method, the image reading apparatus is configured to:
in a case where the continuous reading is set to be enabled as the continuous reading setting, enter a state of waiting to receive a continuation instruction via the user interface;
in the state of waiting to receive the continuation instruction, in a case where the continuation instruction is received, cause the reading device to read an image of a subsequent document; and
in the state of waiting to receive the continuation instruction, in a case where the continuation instruction is not received, combine image data obtained through all readings performed thus far and output the combined data; and
in a case where the continuous reading is set to be disabled as the continuous reading setting, not enter a state of waiting to receive a continuation instruction, and combine image data obtained through all readings performed thus far and output the combined data, and
wherein, in response to completion of reading using the second method, the image reading apparatus is configured to:
regardless of whether the continuous reading is set to be enabled or disabled as the continuous reading setting, enter a state of waiting to receive a continuation instruction via the user interface; and
in the state of waiting to receive the continuation instruction, in a case where the continuation instruction is received, cause the reading device to read an image of a subsequent document; and
in the state of waiting to receive the continuation instruction, in a case where the continuation instruction is not received, combine image data obtained through all readings performed thus far and output the combined data.

2. The image reading apparatus according to claim 1,
wherein, in response to completion of reading using the first method in response to reception of the continuation instruction, the image reading apparatus is configured to:
in the case where the continuous reading is set to be enabled as the continuous reading setting, enter a state of waiting to receive another continuation instruction via the user interface;
in the state of waiting to receive the other continuation instruction, in a case where the other continuation instruction is received, cause the reading device to read an image of a subsequent document; and
in the state of waiting to receive the other continuation instruction, in a case where the other continuation instruction is not received, combine image data obtained through all readings performed thus far and output the combined data; and
in the case where the continuous reading is set to be disabled as the continuous reading setting, not enter a state of waiting to receive another continuation instruction, and combine image data obtained through all readings performed thus far and output the combined data, and
wherein, in response to completion of reading using the second method in response to reception of the continuation instruction, the image reading apparatus is configured to:
regardless of whether the continuous reading is set to be enabled or disabled as the continuous reading setting, enter a state of waiting to receive another continuation instruction via the user interface;
in the state of waiting to receive the continuation instruction, in a case where the continuation instruction is received, cause the reading device to read an image of a subsequent document; and
in the state of waiting to receive the other continuation instruction, in a case where the other continuation instruction is not received, combine image data obtained through all readings performed thus far and output the combined data.

3. The image reading apparatus according to claim 1, further comprising:
a document sensor configured to output different signals depending on whether a document is present or absent in the automatic document feeder;
a cover including the automatic document feeder, the cover being movable, with respect to the document table, between an opened state and a closed state in which the automatic document feeder is ready to convey a document; and
a cover sensor configured to output different signals depending on whether the cover is in the opened state or the closed state with respect to the document table,
wherein the image reading apparatus is configured to:
detect movement of the cover between the opened state and the closed state with respect to the document table, based on a signal output from the cover sensor in the state of waiting to receive the continuation instruction; and
in a case where the continuation instruction is received in the state of waiting to receive the continuation instruction, determine whether a document is detected in the automatic document feeder, based on the signal output from the document sensor, and
wherein, in a case where a document is not detected in the automatic document feeder, the image reading apparatus is configured to:
in a case where the image reading apparatus does not detect movement of the cover between the opened state and the closed state with respect to the document table in the state of waiting to receive the continuation instruction, enter a state of waiting to receive a selection as to whether to perform reading using the first method or reading using the second method, and perform reading of a subsequent document in accordance with the selection received; and
in a case where the image reading apparatus detects movement of the cover between the opened state and the closed state with respect to the document table in the state of waiting to receive the continuation instruction, not enter the state of waiting to receive the selection, and perform reading on a subsequent document using the second method.

4. The image reading apparatus according to claim 3,
wherein the image reading apparatus is configured to, in the case where a document is detected in the automatic document feeder:
in a case where the image reading apparatus detects movement of the cover between the opened state and the closed state with respect to the document table in the state of waiting to receive the continuation instruction, enter the state of waiting to receive the selection as to whether to perform reading using the first method or reading using the second method, and perform reading of a subsequent document in accordance with the selection received; and
in a case where the image reading apparatus does not detect movement of the cover between the opened state and the closed state with respect to the document table in the state of waiting to receive the continuation instruction, not enter the state of waiting to receive the selection, and perform reading of a subsequent document using the first method.

5. The image reading apparatus according to claim 1, further comprising:
a document sensor configured to output different signals depending on whether a document is present or absent in the automatic document feeder;
a cover including the automatic document feeder, the cover being movable, with respect to the document table, between an opened state and a closed state in which the automatic document feeder is ready to convey a document; and
a cover sensor configured to output different signals depending on whether the cover is in the opened state or the closed state with respect to the document table,
wherein the image reading apparatus is configured to:
detect movement of the cover between the opened state and the closed state with respect to the document table, based on a signal output from the cover sensor in the state of waiting to receive the continuation instruction; and
in a case where the continuation instruction is received in the state of waiting to receive the continuation instruction, determine whether a document is detected in the automatic document feeder, based on the signal output from the document sensor, and
wherein, in a case where a document is detected in the automatic document feeder, the image reading apparatus is configured to:
in a case where the image reading apparatus detects movement of the cover between the opened state and the closed state with respect to the document table in the state of waiting to receive the continuation instruction, enter a state of waiting to receive a selection as to whether to perform reading using the first method or reading using the second method, and perform reading of a subsequent document in accordance with the selection; and
in a case where the image reading apparatus does not detect movement of the cover between the opened state and the closed state with respect to the document table in the state of waiting to receive the continuation instruction, not enter the state of waiting to receive the selection, and perform reading using the first method on a subsequent document.

6. The image reading apparatus according to claim 1,
wherein the image reading apparatus is configured to set a reading surface setting as to whether reading using the first method is double-sided reading or single-sided reading, based on an operation via the user interface,
wherein, in reading using the first method, the image reading apparatus is configured to:
in a case where the double-sided reading is set as the reading surface setting, perform double-sided reading in which the reading device reads images of both a first surface of a document and a second surface of the document, the second surface being a back surface of the first surface; and
in a case where the single-sided reading is set as the reading surface setting, perform single-sided reading in which the reading device reads an image of the first surface of the document and does not read an image of the second surface, and
wherein, in a case where a subsequent reading using the first method is followed by a preceding reading using the first method, in response to reception of the continuation instruction in the state of waiting to receive the continuation instruction, the image reading apparatus is further configured to:
in a case where the double-sided reading is set in the preceding reading using the first method, perform the double-sided reading in the subsequent reading using the first method without receiving a reading surface setting for the subsequent reading via the user interface; and
in a case where the single-sided reading is set in the preceding reading using the first method, perform the single-sided reading in the subsequent reading using the first method without receiving a reading surface setting for the subsequent reading via the user interface.

7. The image reading apparatus according to claim 6,
wherein the image reading apparatus is configured to:
in a case where the double-sided reading is set as the reading surface setting, and a subsequent reading using the first method is followed by a preceding reading using the second method, in response to reception of the continuation instruction in the state of waiting to receive the continuation instruction, perform the double-sided reading in the subsequent reading using the first method without receiving a reading surface setting for the subsequent reading via the user interface; and
in a case where the single-sided reading is set as the reading surface setting, and a subsequent reading using the first method is followed by a preceding reading using the second method in response to reception of the continuation instruction in the state of waiting to receive the continuation instruction, perform the single-sided reading in the subsequent reading using the first method without receiving a reading surface setting for the subsequent reading via the user interface.

8. An image reading apparatus comprising:
a document table;
an automatic document feeder;
a user interface;
a reading device;
a document sensor configured to output different signals depending on whether a document is present or absent in the automatic document feeder;
a cover including the automatic document feeder, the cover being movable, with respect to the document table, between an opened state and a closed state in which the automatic document feeder is ready to convey a document; and
a cover sensor configured to output different signals depending on whether the cover is in the opened state or the closed state with respect to the document table,
wherein the image reading apparatus is configured to perform reading using:
a first method in which the reading device reads an image of a document being conveyed by the automatic document feeder and image data is generated based on a reading result; or
a second method in which the reading device reads an image of a document placed on the document table while the reading device is moved along the document table, and image data is generated based on a reading result,
wherein the image reading apparatus is further configured to perform continuous reading,
wherein, in the continuous reading, the image reading apparatus is configured to:
enter a state of waiting to receive a continuation instruction via the user interface after reading using the first method or reading using the second method is performed;
in the state of waiting to receive the continuation instruction, in a case where the continuation instruction is received, cause the reading device to read an image of a subsequent document; and
in the state of waiting to receive the continuation instruction, in a case where the continuation instruction is not received, combine image data obtained through all readings performed thus far and output the combined data,
wherein the image reading apparatus is further configured to:
detect movement of the cover between the opened state and the closed state with respect to the document table, based on a signal output from the cover sensor in the state of waiting to receive the continuation instruction; and
in a case where the continuation instruction is received in a state of waiting to receive the continuation instruction, determine whether a document is detected in the automatic document feeder based on the signal output from the document sensor, and
wherein, in a case where no document is detected in the automatic document feeder, the image reading apparatus is configured to:
in a case where the image reading apparatus does not detect movement of the cover between the opened state and the closed state with respect to the document table in the state of waiting to receive the continuation instruction, enter a state of waiting to receive a selection as to whether to perform reading using the first method or reading using the second method, and perform reading of a subsequent document in accordance with the selection; and
in a case where the image reading apparatus detects movement of the cover between the opened state and the closed state with respect to the document table in the state of waiting to receive the continuation instruction, not enter the state of waiting to receive the selection, and perform reading of a subsequent document using the second method.

9. The image reading apparatus according to claim 8,
wherein the image reading apparatus is configured to, in the case where a document is detected in the automatic document feeder:
in a case where the image reading apparatus detects movement of the cover between the opened state and the closed state with respect to the document table in the state of waiting to receive the continuation instruction, enter the state of waiting to receive the selection as to whether to perform reading using the first method or reading using the second method, and perform reading of a subsequent document in accordance with the selection; and
in a case where the image reading apparatus does not detect movement of the cover between the opened state and the closed state with respect to the document table in the state of waiting to receive the continuation instruction, not enter the state of waiting to receive the selection, and perform reading of a subsequent document using the first method.

10. An image reading apparatus comprising:
a document table;
an automatic document feeder;
a user interface;
a reading device;
a document sensor configured to output different signals depending on whether a document is present or absent in the automatic document feeder;
a cover including the automatic document feeder, the cover being movable, with respect to the document table, between an opened state and a closed state in which the automatic document feeder is ready to convey a document; and
a cover sensor configured to output different signals depending on whether the cover is in the opened state or the closed state with respect to the document table,
wherein the image reading apparatus is configured to perform:
reading using a first method in which the reading device reads an image of a document being conveyed by the automatic document feeder and image data is generated based on a reading result; and
reading using a second method in which, the reading device reads an image of a document placed on the document table while the reading device is moved along the document table, and image data is generated based on a reading result,
wherein the image reading apparatus is further configured to perform continuous reading,
wherein, in the continuous reading, the image reading apparatus is configured to:
enter a state of waiting to receive a continuation instruction via the user interface after reading using the first method or reading using the second method is performed;
in the state of waiting to receive the continuation instruction, in a case where the continuation instruction is received, cause the reading device to read an image of a subsequent document; and,
in the state of waiting to receive the continuation instruction, in a case where the continuation instruction is not received, combine image data obtained through all readings performed thus far and output the combined data,
wherein the image reading apparatus is further configured to:
detect movement of the cover between the opened state and the closed state with respect to the document table, based on a signal output from the cover sensor in the state of waiting to receive the continuation instruction; and
in a case where the continuation instruction is received in the state of waiting to receive the continuation instruction, determine whether a document is detected in the automatic document feeder based on the signal output from the document sensor, and
wherein, in a case where a document is detected in the automatic document feeder, the image reading apparatus is configured to:
in a case where the image reading apparatus detects movement of the cover between the opened state and the closed state with respect to the document table in the state of waiting to receive the continuation instruction, enter a state of waiting to receive a selection as to whether to perform reading using the first method or reading using the second method, and perform reading of a subsequent document in accordance with the selection; and
in a case where the image reading apparatus does not detect movement of the cover between the opened state and the closed state with respect to the document table in the state of waiting to receive the continuation instruction, not enter the state of waiting to receive the selection, and perform reading of a subsequent document using the first method.

11. An image reading apparatus comprising:
a document table;
an automatic document feeder;
a user interface; and
a reading device,
wherein the image reading apparatus is configured to perform:
reading using a first method in which the reading device reads an image of a document being conveyed by the automatic document feeder and image data is generated based on a reading result; and
reading using a second method in which the reading device reads an image of a document placed on the document table while the reading device is moved along the document table, and image data is generated based on a reading result,
wherein the image reading apparatus is further configured to perform continuous reading,
wherein, in the continuous reading, the image reading apparatus is configured to:
enter a state of waiting to receive a continuation instruction via the user interface after reading using the first method or reading using the second method is performed;
in the state of waiting to receive the continuation instruction, in a case where the continuation instruction is received, cause the reading device to read an image of a subsequent document; and
in the state of waiting to receive the continuation instruction, in a case where the continuation instruction is not received, combine image data obtained through all readings performed thus far and output the combined data,
wherein the image reading apparatus is configured to determine a reading surface setting as to whether reading using the first method is double-sided reading or single-sided reading, according to an operation via the user interface,
wherein, in reading using the first method, the image reading apparatus is configured to:
in a case where the double-sided reading is set as the reading surface setting, perform double-sided reading in which the reading device reads images of both a first surface of a document and a second surface of the document, the second surface being a back surface of the first surface; and
in a case where the single-sided reading is set as the reading surface setting, perform single-sided reading in which the reading device reads an image of the first surface of the document and does not read an image of the second surface, and
wherein, in a case where a subsequent reading using the first method is followed by a preceding reading using the first method, in response to reception of the continuation instruction in the state of waiting to receive the continuation instruction, the image reading apparatus is further configured to:
in a case where the double-sided reading is set in the preceding reading using the first method, perform the double-sided reading in the subsequent reading using the first method without receiving a reading surface setting for the subsequent reading via the user interface; and
in a case where the single-sided reading is set in the preceding reading using the first method, perform the single-sided reading in the subsequent reading using the first method without receiving a reading surface setting for the subsequent reading via the user interface.

12. The image reading apparatus according to claim 11,
wherein the image reading apparatus is configured to:
in a case where the double-sided reading is set as the reading surface setting, and a subsequent reading using the first method is followed by a preceding reading using the second method, in response to reception of the continuation instruction in the state of waiting to receive the continuation instruction, perform the double-sided reading in the subsequent reading using the first method without receiving a reading surface setting for the subsequent reading via the user interface; and
in a case where the single-sided reading is set as the reading surface setting, and a subsequent reading using the first method is followed by a preceding reading using the second method in response to reception of the continuation instruction in the state of waiting to receive the continuation instruction, perform the single-sided reading in the subsequent reading using the first method without receiving a reading surface setting for the subsequent reading via the user interface.

13. The image reading apparatus according to claim 11,
wherein the reading device includes a plurality of devices, the plurality of devices including a first-surface reading device and a second-surface reading device,
wherein, in the double-sided reading, the image reading apparatus is configured to cause the first-surface reading device to read an image of the first surface of the document, and configured to cause the second-surface reading device to read an image of the second surface of the document, and
wherein, in the single-sided reading, the image reading apparatus is configured to cause the first-surface reading device to read an image of the first surface of the document, and configured not to cause the second-surface reading device to read an image of the second surface of the document.

14. The image reading apparatus according to claim 1,
wherein the image reading apparatus is configured to read a document using the reading device common to reading using the first method and reading using the second method, and
wherein the image reading apparatus is configured to:
in reading using the first method, position the reading device at a predetermined position and cause the reading device to read an image of a document being conveyed by the automatic document feeder; and
in reading using the second method, cause the reading device to read an image of a document placed on the document table while moving the reading device along the document table.

15. The image reading apparatus according to claim 1,
wherein the reading device includes a plurality of devices, the plurality of devices including a first reading device and a second reading device, and
wherein the image reading apparatus is configured to:
in reading using the first method, cause the first reading device to read an image of a document being conveyed by the automatic document feeder; and
in reading using the second method, cause the second reading device to read an image of a document placed on the document table while moving the second reading device along the document table.

16. The image reading apparatus according to claim 8,
wherein the image reading apparatus is configured to read a document using the reading device common to reading using the first method and reading using the second method, and
wherein the image reading apparatus is configured to:
in reading using the first method, position the reading device is at a predetermined position and cause the reading device to read an image of a document being conveyed by the automatic document feeder; and
in reading using the second method, cause the reading device to read an image of a document placed on the document table while moving the reading device along the document table.

17. The image reading apparatus according to claim 8,
wherein the reading device includes a plurality of devices, the plurality of devices including a first reading device and a second reading device, and
wherein the image reading apparatus is configured to:
in reading using the first method, cause the first reading device to read an image of a document being conveyed by the automatic document feeder; and
in reading using the second method, cause the second reading device to read an image of a document placed on the document table while moving the second reading device along the document table.

18. The image reading apparatus according to claim 10,
wherein the image reading apparatus is configured to read a document using the reading device common to reading using the first method and reading using the second method, and
wherein the image reading apparatus is configured to:
in reading using the first method, position the reading device at a predetermined position and cause the reading device to read an image of a document being conveyed by the automatic document feeder; and
in reading using the second method, cause the reading device is caused to read an image of a document placed on the document table while moving the reading device along the document table.

19. The image reading apparatus according to claim 10,
wherein the reading device includes a plurality of devices, the plurality of devices including a first reading device and a second reading device, and
wherein the image reading apparatus is configured to:
in reading using the first method, cause the first reading device to read an image of a document being conveyed by the automatic document feeder; and
in reading using the second method, cause the second reading device to read an image of a document placed on the document table while moving the second reading device along the document table.

20. The image reading apparatus according to claim 11,
wherein the image reading apparatus is configured to read a document using the reading device common to reading using the first method and reading using the second method, and
wherein the image reading apparatus is configured to:
in reading using the first method, position the reading device at a predetermined position and cause the reading device to read an image of a document being conveyed by the automatic document feeder; and
in reading using the second method, cause the reading device is caused to read an image of a document placed on the document table while moving the reading device along the document table.

21. The image reading apparatus according to claim 11,
wherein the reading device includes a plurality of devices, the plurality of devices including a first reading device and a second reading device, and
wherein the image reading apparatus is configured to:
in reading using the first method, cause the first reading device to read an image of a document being conveyed by the automatic document feeder; and
in reading using the second method, cause the second reading device to read an image of the document placed on the document table while moving the second reading device along the document table.
